(19) United States
(12) Patent Application Publication
(10) Pub. No.: US 2013/0164048 A1
(43) Pub. Date: Jun. 27, 2013

(54) COLOR REGISTRATION SENSOR FOR IMAGE FORMING APPARATUS, METHOD OF DETECTING REGISTRATION TEST PATTERNS BY USING THE COLOR REGISTRATION SENSOR, AND IMAGE FORMING APPARATUS INCLUDING THE COLOR REGISTRATION SENSOR

(71) Applicant: SAMSUNG ELECTRONICS CO., LTD., Suwon-si (KR)

(72) Inventors: Tatsuhiro OTSUKA, Suwon-si (KR); Ki-hwan Kwon, Hwaseong-si (KR); Soon-cheol Kweon, Seoul (KR); Dong-woo Ha, Hwaseong-si (KR)

(73) Assignee: SAMSUNG ELECTRONICS CO., LTD., Suwon-si (KR)

(21) Appl. No.: 13/721,242

(22) Filed: Dec. 20, 2012

(30) Foreign Application Priority Data
Dec. 23, 2011 (KR) 10-2011-0141705

(51) Int. Cl. G03G 15/01

(52) U.S. Cl. CPC G03G 15/5025
USPC 399/301

(57) ABSTRACT

A color registration sensor of an image forming apparatus, and a method of detecting registration test patterns of a plurality of colors formed on a transfer medium, by using the color registration sensor. The color registration sensor detects a current generated by an electric force of a charged toner forming registration test patterns by using an electrode, as the registration test patterns of a plurality of colors formed on the transfer medium approach the color registration sensor, and detects a location of each of the registration test patterns of the plurality of colors by using a voltage signal obtained by converting the detected current.

### CROSS-REFERENCE TO RELATED APPLICATIONS

This application claims the benefit of Korean Patent Application No. 10-2011-0141705, filed on Dec. 23, 2011, in the Korean Intellectual Property Office, the disclosure of which is incorporated herein in its entirety by reference.

### BACKGROUND

1. Field

The present disclosure relates to a color registration sensor, a method of detecting registration test patterns by using the color registration sensor, and an image forming apparatus including the color registration sensor.

2. Description of the Related Art

An image forming apparatus includes a function of forming a color image, detecting registration test patterns by using a color registration sensor, and calculating an error of color registration based on locations of the detected registration test patterns. The image forming apparatus compensates for the error by controlling each unit of the image forming apparatus, according to the calculated error.

Here, in order to prevent deterioration of the color image due to the error, a method of accurately detecting the registration test patterns is required.

### SUMMARY

The present disclosure provides a color registration sensor, a method of detecting registration test patterns by using the color registration sensor, and an image forming apparatus including the color registration sensor.

The present disclosure also provides a computer readable recording medium having recorded thereon a program for executing the method.

Additional aspects will be set forth in part in the description which follows and, in part, will be apparent from the description, or may be learned by practice of the presented embodiments.

According to an aspect, there is provided a color registration sensor of an image forming apparatus, the color registration sensor including: a first electrode for detecting a current generated by an electric force of a charged toner forming registration test patterns, as the registration test patterns of a plurality of colors formed on a transfer medium of the image forming apparatus approach the color registration sensor; a first voltage generator for generating a first voltage signal corresponding to the current, by converting the current; and a signal processor for detecting a location of each of the registration test patterns of the plurality of colors by using the first voltage signal.

According to another aspect, there is provided an image forming apparatus comprising a color registration sensor, the image forming apparatus including: an exposure unit for generating an electrostatic latent image consisting of electrostatic charge formed by irradiating a light on a photoconductor according to colors; a developing unit for generating a toner image by developing the electrostatic latent image by using a charged toner; a transfer unit for transferring the toner image to a transfer medium; a color registration sensor for detecting a current generated by an electric force of a charged toner forming registration test patterns by using a first electrode, as the registration test patterns of a plurality of colors formed on the transfer medium approach the color registration sensor, generating a first voltage signal corresponding to the current, by converting the current, and detecting a location of each of the registration test patterns of the plurality of colors by using the first voltage signal; a color registration error calculator for calculating an error of color registration by using the location of each of the registration test patterns detected by the color registration sensor; and a controller for controlling units of the image forming apparatus based on the calculated error, so as to compensate for the error.

According to another aspect, there is provided a method of detecting registration test patterns of a plurality of colors formed on a transfer medium by using a color registration sensor of an image forming apparatus, the method including: detecting a current generated by an electric force of a toner forming registration test patterns by using a first electrode, as the registration test patterns of a plurality of colors formed on the transfer medium of the image forming apparatus approach the color registration sensor; generating a first voltage signal corresponding to the current by converting the current; and detecting a location of each of the registration test patterns of the plurality of colors by using the first voltage signal.

According to another aspect, there is provided a computer readable recording medium having recorded thereon a program for executing the method above.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a block diagram of a color registration sensor according to an embodiment;

FIG. 2 is a block diagram of a color registration sensor according to an embodiment;

FIG. 3 is a reference diagram for describing registration test patterns of a plurality of colors detected by a color registration sensor, according to an embodiment;

FIG. 4A is a diagram for describing an operation of detecting registration test patterns formed on a transfer medium of an image forming apparatus, by using the color registration sensor of FIG. 1;

FIG. 4B is a diagram for describing generation of a current by an electric force of a charged toner in a first electrode of FIG. 1;

FIG. 4C is a graph showing a waveform of a current generated in the first electrode of FIG. 1;

FIG. 5A is a diagram of a color registration sensor including a signal processor, according to an embodiment;

FIG. 5B is a graph showing signals processed by the signal processor of FIG. 5A, according to an embodiment;

FIG. 6A is a diagram of a color registration sensor including a signal processor, according to an embodiment;

FIG. 6B is a graph showing signals processed by the signal processor of FIG. 6A, according to an embodiment;

FIG. 7A is a diagram of an electrode unit of FIG. 2, according to an embodiment;

FIG. 7B is a diagram of the electrode unit of FIG. 2, according to an embodiment;

FIG. 8 is a diagram of an image forming apparatus including a color registration sensor, according to an embodiment;

FIG. 9 is a diagram for describing a location of a color registration sensor in an image forming apparatus, according to an embodiment;

FIG. 10 is a flowchart illustrating a method of detecting registration test patterns by using a color registration sensor, according to an embodiment; and

FIG. 11 is a flowchart illustrating a method of detecting registration test patterns by using a color registration sensor, according to an embodiment.

### DETAILED DESCRIPTION

Hereinafter, the present disclosure will be described more fully with reference to the accompanying drawings, in which exemplary embodiments of the invention are shown.

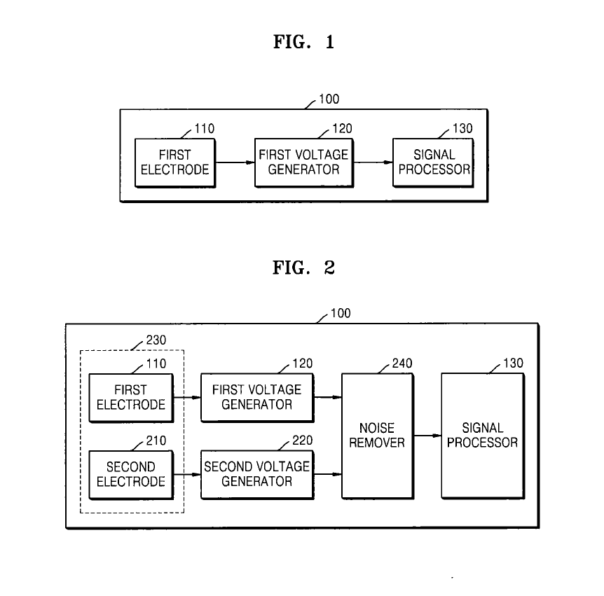

FIG. 1 is a block diagram of a color registration sensor 100 according to an embodiment of the present invention. Referring to FIG. 1, the color registration sensor 100 may include a first electrode 110, a first voltage generator 120, and a signal processor 130.

FIG. 1 shows elements of the color registration sensor 100 related to the current embodiment. Thus, it would be obvious to one of ordinary skill in the art that other general-purpose elements may be included in the color registration sensor 100 of FIG. 1.

The color registration sensor 100 may be used for an image forming apparatus or a multi-function peripheral (MFP), but is not limited thereto. For convenience of description, the color registration sensor 100 is used for an image forming apparatus.

As registration test patterns of a plurality of colors formed on a transfer medium (not shown) of an image forming apparatus approach the color registration sensor 100, the first electrode 110 detects a current generated by an electric force of a charged toner forming the registration test patterns.

Here, the registration test patterns of the colors formed on the transfer medium may be developed by using a toner charged according to colors. Thus, the registration test patterns are charged in positive (+) or negative (−) charge.

Accordingly, when the registration test patterns move along the transfer medium and approach the first electrode 110, an electrostatic induction phenomenon is generated in the first electrode 110 by the electric force of the charged toner forming the registration test patterns. In other words, as the charged toner forming the registration test patterns approach the first electrode 110, a charge is induced on a surface of the first electrode 110.

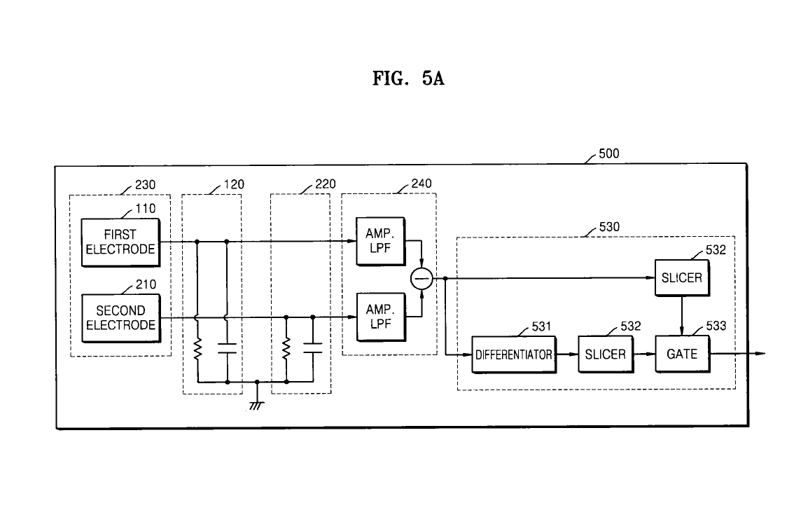

As such, free electrons move in the first electrode 110 according to the electrostatic induction phenomenon, and a current is generated in the first electrode 110. Details will be described later with reference to FIG. 4A.

The first electrode 110 according to an embodiment may be formed of a conductor, such as a metal so as to have a charge induced on its surface by a charged body.

The first voltage generator 120 converts the current detected by the first electrode 110 to generate a first voltage signal corresponding to the detected current. The first voltage generator 120 according to an embodiment may be realized by using a resistor.

The signal processor 130 detects a location of a registration test pattern of each color by using the first voltage signal. The signal processor 130 may perform various signal processes by using the first voltage signal so as to detect an accurate location of a registration test pattern.

For example, the signal processor 130 according to an embodiment may detect a location of a registration test pattern by using a peak location of the first voltage signal.

By detecting the location of the registration test pattern by using the first electrode 110, the color registration sensor 100 according to an embodiment may prevent an error from being generated due to an installation angle or location of the color registration sensor 100 while detecting the location.

Also, the color registration sensor 100 according to an embodiment is very economical in terms of expenses, since a light source, such as a laser diode (LD) or a luminescent diode (LED), or a lens for irradiating and reflecting a light is not used.

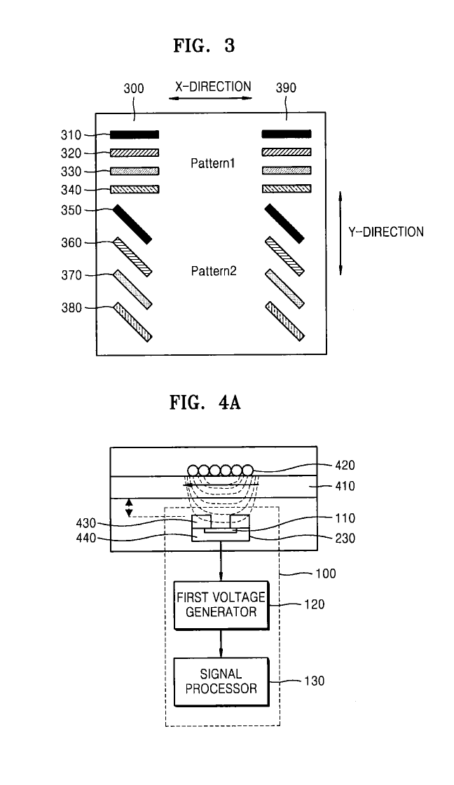

FIG. 2 is a block diagram of the color registration sensor 100 according to an embodiment. Referring to FIG. 2, the color registration sensor 100 includes the first electrode 110, a second electrode 210, the first voltage generator 120, a second voltage generator 220, a noise remover 240, and the signal processor 130.

The first electrode 110, the first voltage generator 120, the signal processor 130 of FIG. 2 respectively correspond to the first electrode 110, the first voltage generator 120, and the signal processor 130 of FIG. 1, and thus overlapping details are not described herein. However, units of the color registration sensor 100 are not limited to those shown in FIG. 2.

As described above with reference to FIG. 1, as registration test patterns of a plurality of colors formed on a transfer medium (not shown) of an image forming apparatus approach the color registration sensor 100, the first electrode 110 detects a current generated by an electric force of a charged toner forming the registration test patterns.

The second electrode 210 detects a current for removing a noise signal included in the current detected by the first electrode 110. The first electrode 110 detects a current generated by an electrostatic induction phenomenon. Here, since the first electrode 110 is in a floating state in terms of circuits, the current detected by the first electrode 110 may include a current corresponding to a noise signal due to an effect of a commercial power supply frequency.

Also, since the image forming apparatus performs developing and transferring on the transfer medium, a high voltage used during the developing and transferring may be transmitted to the transfer medium. Accordingly, the current detected by the first electrode 110 may include a current corresponding to the noise signal.

Furthermore, the color registration sensor 100 detects the registration test patterns on the transfer medium. Thus, an interval between the color registration sensor 100 and the transfer medium changes as the transfer medium moves up and down or vibrates, and thus the current detected by the first electrode 110 may include the current corresponding to the noise signal.

Accordingly, the color registration sensor 100 according to an embodiment locates the second electrode 210 near the first electrode 110, and the second electrode 210 detects the current for removing the noise signal generated in the first electrode 110.

The first voltage generator 120 generates a first voltage signal corresponding to the current detected by the first electrode 110 by converting the current detected by the first electrode 110.

The second voltage generator 220 generates a second voltage signal corresponding to the current detected by the second electrode 210 by converting the current detected by the second electrode 210.

The noise remover 240 removes the noise signal from the first voltage signal by using the second voltage signal. The second electrode 210 detects a signal for removing the noise generated in the first electrode 110 by being disposed near the first electrode 110. Accordingly, the noise remover 240 obtains a noise removed voltage signal by subtracting the second voltage signal from the first voltage signal.

The noise remover 240 according to an embodiment may be a subtracter, but is not limited thereto.

Also, the noise remover 240 may further include an amplifier for amplifying a voltage signal, and a low pass filter (LPF) for removing a high frequency noise signal from the amplified voltage signal.

As described above with reference to FIG. 1, the signal processor 130 detects a location of each registration test pattern of colors by using the noise removed voltage signal. In order to detect an accurate location of the registration test pattern, the signal processor 130 may perform various signal processes by using the noise removed voltage signal.

Accordingly, the color registration sensor 100 according to an embodiment may effectively detect a registration test pattern at a low cost by using a current generated by an electric force of a charged toner forming registration test patterns, by using an electrode.

Also, since the color registration sensor 100 according to an embodiment does not use light, the registration test patterns may be detected without being affected by an installation location of the color registration sensor 100, a location of a light source, an angle of a lens irradiating and reflecting a light.

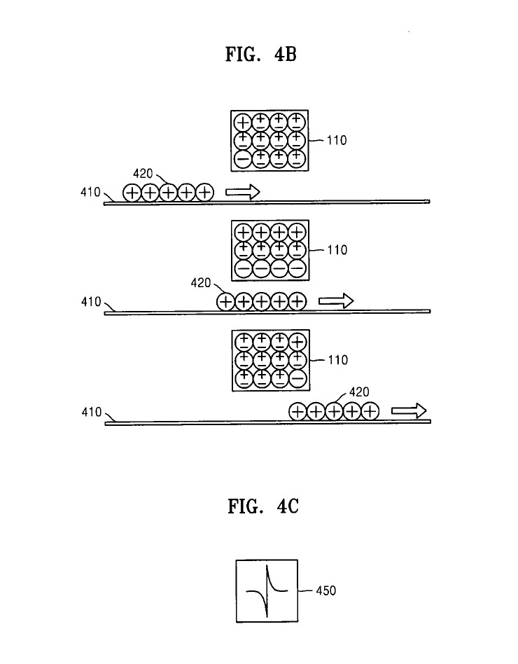

FIG. 3 is a reference diagram for describing registration test patterns of a plurality of colors detected by a color registration sensor, according to an embodiment.

Referring to FIG. 3, the registration test patterns formed on a transfer medium include first registration test patterns 300 and second registration test patterns 390. The first registration test patterns 300 have first shapes and second shapes.

The first shape may be a bar shape perpendicular to a heading direction of the registration test patterns, and the second shape may be a slant shape tilting in both the heading direction of the registration test patterns and a direction perpendicular to the heading direction.

The first registration test patterns 300 includes a first color pattern 310, a second color pattern 320, a third color pattern 330, and a fourth color pattern 340, which are in the first shape, and a first color pattern 350, a second color pattern 360, a third color pattern 370, and a fourth color pattern 380, which are in the second shape.

Also, the first color patterns 310 and 350, the second color patterns 320 and 360, the third color patterns 330 and 370, and the fourth color patterns 340 and 380 may be respectively in black (K), cyan (C), magenta (M), and yellow (Y). The first color patterns 310 and 350, the second color patterns 320 and 360, the third color patterns 330 and 370, and the fourth color patterns 340 and 380 are transferred to and formed on the transfer medium respectively by black, cyan, magenta, and yellow toners.

In order to detect each of the first and second registration test patterns 300 and 390, two color registration sensors 100 may be disposed to face each other across the transfer medium.

The color registration sensor 100 detects the first color patterns 310 and 350, the second color patterns 320 and 360, the third color patterns 330 and 370, and the fourth color patterns 340 and 380 in the first and second shapes, and detects the second registration test patterns 390 parallel to the first registration test patterns 300, thereby detecting an error in an x-direction, an error in a y-direction, a print width error, a skew error, etc. according to colors.

As described above, the color registration sensor 100 detects the registration test patterns according to colors formed on the transfer medium of the image forming apparatus.

FIG. 4A is a diagram for describing an operation of detecting registration test patterns 420 formed on a transfer medium 410 of an image forming apparatus, by using the color registration sensor 100 of FIG. 1.

The color registration sensor 100 of FIG. 4A includes an electrode unit 230, the first voltage generator 120, and the signal processor 130, wherein the electrode unit 230 includes the first electrode 110, an aperture 430, and a ground plate 440.

The color registration sensor 100 according to an embodiment detects the registration test pattern 420 formed on the transfer medium 410. Here, the registration test pattern is developed on the transfer medium 410 by using a charged toner, wherein the charged toner has a charge q of positive (+) or negative (−) charge.

Referring to FIG. 4A, the registration test pattern 420 is formed on the transfer medium 410, and moves in a direction indicated by arrows as the transfer medium moves 410. Accordingly, the registration test pattern 420 moves along the transfer medium 410 while having the positive or negative charge.

The registration test pattern 420 having a charge forms an electric field E(t) therearound. When another object having a charge enters the electric field, the object receives an electric force proportional to the quantity of charge of the object and inversely proportional to a square of distance (d). Accordingly, when the registration test pattern 420 on the transfer medium 410 approaches the color registration sensor 100 by moving along the transfer medium 410, the first electrode 110 of the color registration sensor 100 receives the electric force according to the charged toner of the registration test pattern 420.

Since the first electrode 110 according to an embodiment is formed of a conductor, an electrostatic induction phenomenon is generated in the first electrode 110 by the charged toner of the registration test pattern 420. In other words, free electrons in the conductor of the first electrode 110 move due to the electric force of the charged toner, and thus the charge is polarized.

For example, when the charged toner has a positive charge, a negative charge is shown near the charged toner and a positive charge is shown far from the charged toner, in the first electrode 110. This will be described in detail below with reference to FIG. 4B. As such, the free electrons move and the current is generated in the first electrode 110 according to the electrostatic induction phenomenon due to the charged toner.

Accordingly, the first electrode 110 detects the current generated by the electric force of the charged toner forming the registration test pattern 420.

The aperture 430 determines a surface to be exposed to an external space from among an electrode plate forming the first electrode 110. Accordingly, the first electrode 110 detects the registration test pattern 420 on the transfer medium 410 through the surface exposed by the aperture 430.

The ground plate 440 grounds remaining portions of the electrode plate forming the first electrode 110, except the surface exposed by the aperture 430. The first electrode 110 is grounded through the ground plate 440 so as to reduce noise generated in the color registration sensor 100 itself.

The first voltage generator 120 generates the first voltage signal by converting the current detected by the first electrode 110.

The signal processor 130 detects a location of the registration test pattern 420 of each color by using the first voltage signal.

Accordingly, the color registration sensor 100 may detect the location of the registration test pattern 420 of each color by using the electric force of the charged toner forming the registration test patterns 420, as the registration test patterns 420 approach the color registration sensor 100.

FIG. 4B is a diagram for describing generation of a current by an electric force of a charged toner in a first electrode 110 of FIG. 1.

Referring to FIG. 4B, the registration test pattern 420 formed by the charged toner moves in a direction indicated by an arrow as the transfer medium 410 moves, and thus approaches the color registration sensor 100. Here, the charged toner may have a charge q in positive or negative charge, and for convenience of description, it is assumed that the toner is charged in a positive charge.

According to an embodiment, as the registration test pattern 420 charged in the positive charge approaches the color registration sensor 100, the first electrode 110 of the color registration sensor 100 receives an electric force by the positive charge of the registration test pattern 420. The first electrode 110 receives the electric force by the positive charge of the registration test pattern 420, thereby generating a polarization phenomenon by an electrostatic induction phenomenon.

Referring to FIG. 4B, charges of the first electrode 110 are polarized by the electric force of the toner having the positive charge. A negative charge is shown near the charged toner and a positive charge is shown far from the charged toner in the first electrode 110.

Also, an area of the first electrode 110 receiving the electric force gradually increases as the charged toner approaches the color registration sensor 100, and gradually disappears as the charged toner recedes from the color registration sensor 100.

Accordingly, an area of the first electrode 110 where the polarization phenomenon is generated gradually increases as the charged toner approaches, and gradually disappears as the charged toner recedes.

The current generated in the first electrode 110 is generated as a charge moves according to the polarization phenomenon, and temporarily appears and then disappears according to a distance between the charged toner and the color registration sensor 100.

Accordingly, the color registration sensor 100 may detect a location of each registration test pattern 420 according to colors formed on the transfer medium 410, by using the current generated in the first electrode 110.

FIG. 4C is a graph showing a waveform 450 of a current generated in the first electrode 110 of FIG. 1.

As described with reference to FIG. 4B, the current generated in the first electrode 110 is a temporary current generated as a charge moves due to the polarization phenomenon. Accordingly, the current generated in the first electrode 110 has the waveform 450 of FIG. 4C.

When registration test patterns of a plurality of colors move along a transfer medium and pass through the color registration sensor 100, according to an embodiment of the present invention, a current having the waveform 450 of FIG. 4C is generated in the first electrode 110 for one registration test pattern. Accordingly, waveforms which have the same form as the waveform 450 are continuously repeated for the registration test patterns of the plurality of colors and are detected via the first electrode 110.

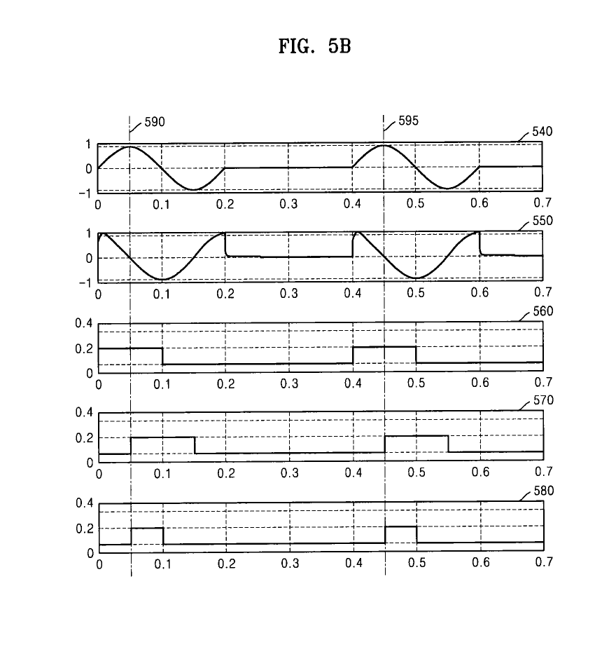

FIG. 5A is a diagram of a color registration sensor 500 including a signal processor 530, according to an embodiment. The color registration sensor 500 of FIG. 5A includes the electrode unit 230, the first voltage generator 120, the second voltage generator 220, the noise remover 240, and the signal processor 530.

The electrode unit 230, the first voltage generator 120, the second voltage generator 220, the noise remover 240, and the signal processor 530 of FIG. 5A respectively correspond to the electrode unit 230, the first voltage generator 120, the second voltage generator 220, the noise remover 240, and the signal processor 130 of FIG. 2, and overlapping details thereof are not described herein.

Elements of the color registration sensor 100 related to the current embodiment are shown in FIG. 5A, and it would have obvious to one of ordinary skill in the art that other general-purpose elements may be further included.

Referring to FIG. 5A, the electrode unit 230 includes the first electrode 110 and the second electrode 210, the noise remover 240 includes an amplifier, an LPF, and a subtracter, and the signal processor 530 includes a differentiator 531, a slicer circuit 532, and a logic gate 533.

The electrode unit 230 detects currents by using the first and second electrodes 110 and 210. Here, the current detected by the first electrode 110 is a current generated by an electric force of a charged toner forming registration test patterns, and the current detected by the second electrode 210 is a current for removing a noise signal included in the current detected by the first electrode 110.

The first voltage generator 120 generates a first voltage signal by converting the current detected by the first electrode 110. Referring to FIG. 5A, the current detected by the first electrode 110 is converted to the first voltage signal by a resistor. The first voltage generator 120 may include one resistor and one capacitor, but is not limited thereto.

The second voltage generator 220 generates a second voltage signal by converting the current detected by the second electrode 210. Referring to FIG. 5A, the current detected by the second electrode 210 is converted to the second voltage signal by a resistor. The second voltage generator 220 may include one resistor and one capacitor, but is not limited thereto.

The noise remover 240 amplifies amplitudes of the first and second voltage signals by using the amplifier, and removes high frequency noise signals included in the first and second voltage signals by using the LPF.

Also, the noise remover 240 removes a noise signal by subtracting the second voltage signal from the first voltage signal from which the high frequency noise signal is removed, so as to remove the noise signal included in the current detected by the first electrode 110.

Since the current detected by the first electrode 110 is a temporary current generated by the electric force of the charged toner, the current may be easily affected by noise. Since the first electrode 110 is circuitly floating, the first electrode 110 may be affected by a commercial power supply frequency. Also, when transferring and developing is performed on the transfer medium, a current corresponding to noise may be generated in the first electrode 110 due to a high voltage used during the transferring and developing.

Furthermore, since the registration test patterns are formed on the transfer medium and move with the transfer medium, the current corresponding to noise may be generated as a distance between the charged toner and the color registration sensor 100 is changed by vibration of the transfer medium.

The noise remover 240 may remove the noise signal included in the first electrode 110 by using the current detected by the second electrode 210.

The color registration sensor 100 according to an embodiment may effectively remove the noise signal by using the first electrode 110 and the second electrode 210 that detects the current for removing the noise signal generated in the first electrode 110.

The signal processor 530 detects a location of each of the registration test patterns of colors by using the first voltage signal from which the noise signal is removed. The signal processor 530 according to the current embodiment detects the location of the registration test pattern by obtaining a peak location of the first voltage signal from which the noise signal is removed. For convenience of description, the first voltage signal from which the noise signal is removed is referred to as a third voltage signal.

The signal processor 530 may obtain the peak location of the third voltage signal by using the third voltage signal. Alternatively, the signal processor 530 may obtain the peak location of the third voltage signal by using a differential signal obtained by differentiating the third voltage signal. For example, the signal processor 530 may obtain the peak location of the third voltage signal by obtaining a point where the differential signal meets 0 (zero), i.e., a zero cross point.

A value of the differential signal at the peak location of the third voltage signal is 0. Accordingly, the signal processor 530 may obtain the peak location of the third voltage signal by using a zero cross point of the differential signal.

However, if the zero cross point of the differential signal is used, noise may be generated near a point where the differential signal is 0, and thus the signal processor 530 may be unable to detect an accurate peak location of the third voltage signal.

Accordingly, in order to remove noise that may be generated when the peak location of the third voltage signal is obtained by using only one signal, both of the third voltage signal and differential signal may be used to obtain the peak location of the third voltage signal. Accordingly, the color registration sensor 100 according to an embodiment may accurately detect the location of the registration test pattern.

However, the method of obtaining the peak location of the third voltage signal is not limited to the above description, and any one of various methods may be used.

The signal processor 530 according to an embodiment may include the differentiator 531, the slicer circuit 532, and the logic gate 533 to obtain the peak location of the third voltage signal by using both of the third voltage signal and the differential signal. Detailed operations of the signal processor 530 are described below with reference to FIG. 5B.

FIG. 5B is a graph showing signals processed by the signal processor 530 of FIG. 5A, according to an embodiment.

A third voltage signal 540 shown in FIG. 5B denotes a first voltage signal from which a noise signal is removed by the noise remover 240. Here, points where the third voltage signal 540 and alternate long and short dash lines 590 and 596 meet are peak locations of the third voltage signal 540.

The signal processor 530 obtains a differential signal 550 obtained by differentiating the third voltage signal 540 by using the differentiator 531. Here, signal levels of the differential signal 550 are 0 at the points where the differential signal 550 and the alternate long and short dash lines 590 and 595 meet. In other words, the signal levels of the differential signals 550 are 0 at the peak locations of the third voltage signal 540.

The signal processor 530 may obtain accurate peak locations of the third voltage signal 540 by obtaining points where the third voltage signal 540 is at the peak and the differential signal 550 is 0.

The signal processor 530 adjusts a value equal to or above a predetermined maximum level to a value of the predetermined maximum level and a value below or equal to a predetermined minimum level to a value of the predetermined minimum level with respect to the third voltage signal 540 and the differential signal 550.

For convenience of description, a signal having a value equal to or above a predetermined maximum level adjusted to a value of the predetermined maximum level and a value below or equal to a predetermined minimum value adjusted to a value of the predetermined minimum value is referred to as a slice signal.

The obtaining of a slice signal by the signal processor 530 according to an embodiment may be realized by the slicer circuit 532, but is not limited thereto.

The signal processor 530 obtains a first slice signal 560 constituting the third voltage signal 540 having adjusted maximum and minimum levels. Also, the signal processor 530 obtains a second slice signal 570 constituting the differential signal 550 having adjusted maximum and minimum levels.

Referring to FIG. 5B, the maximum levels and the minimum levels of the first and second slice signals 560 and 570 have modified, so as to use a logic product on the third voltage signal 540 and the differential signal 550. Here, the maximum levels and minimum levels of the second slice signal 570 are reversed.

The signal processor 530 obtains a peak detection signal 580 by performing a logic product (AND) on the first and second slice signals 560 and 570 by using the logic gate 533. As the signal processor 530 detects the peak locations by using the peak detection signal 580, the differential signal 550 is not affected by a noise signal generated near 0.

Referring to FIG. 5B, the points where the alternate long and short dash lines 590 and 595 passing through the peak locations of the third voltage signal 540 and the peak detection signal 580 meet are the peak locations of the third voltage signal 540. As such, the signal processor 530 obtains the peak locations of the third voltage signal 540 by obtaining points where the peak detection signal 580 change from low (0) to high (0.2).

As such, the signal processor 530 may accurately detect a peak location of a voltage signal without being affected by a noise signal, by using an AND value of the voltage signal from which noise is removed and a differential signal obtained by differentiating the voltage signal. Accordingly, the color registration sensor 100 according to an embodiment of the present invention may accurately detect a location of a registration test pattern.

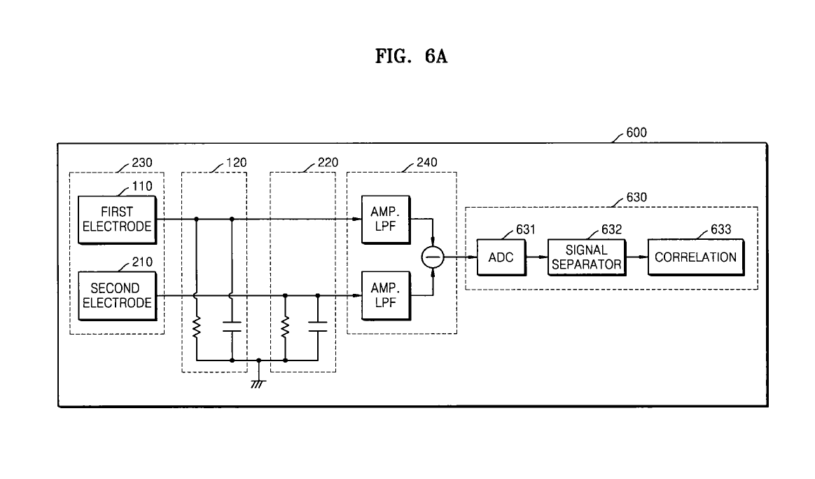

FIG. 6A is a diagram of a color registration sensor 600 including a signal processor 630, according to an embodiment. The color registration sensor 600 of FIG. 6A includes the electrode unit 230, the first voltage generator 120, the second voltage generator 220, the noise remover 240, and the signal processor 630.

Since the electrode unit 230, the first voltage generator 120, the second voltage generator 220, the noise remover 240, and the signal processor 630 of FIG. 6A are identical to the electrode unit 230, the first voltage generator 120, the second voltage generator 220, the noise remover 240, and the signal processor 530 of FIG. 5A, overlapping details thereof are not described herein.

Referring to FIG. 6A, the signal processor 630 includes an analog/digital converter (ADC) 631, a signal separator 632, and a correlation calculator 633.

The signal processor 630 according to an embodiment detects a location of each of registration test patterns of a plurality of colors by calculating correlations of one signal for one color with signals for other colors.

Here, the signal processor 630 may calculate the correlations of the signal of one color with the signals of other colors by using a digital signal of each color, or by using an analog signal of each color. Here, the correlation is shown in a numerical value of a mutual relation between at least two different pieces of data.

The signal processor 630 according to an embodiment converts a voltage signal constituting an analog signal from which a noise signal is removed (hereinafter, referred to as a third voltage signal for convenience of description) to a digital signal. Here, the ADC 631 may convert an analog signal to a digital signal.

The signal processor 630 extracts a digital signal of each color from the converted third voltage signal. Since the third voltage signal includes information about all voltage signals of the plurality of colors, the digital signal of each color is extracted so as to calculate correlations between the digital signals of the plurality of colors. Accordingly, the third voltage signal constituting the digital signals of the plurality of colors is separated into digital signals of each color.

The signal processor 630 calculates the correlations of the digital signal of one color with the digital signals of other colors by using the extracted digital signals.

For example, the signal processor 630 calculates the correlation of the digital signal of black with the digital signal of cyan, thereby obtaining a location where the two digital signals have the largest correlation. Also, the signal processor 630 calculates the correlation of the digital signal of black with the digital signal of magenta, thereby obtaining a location where the two digital signals have the largest correlation. Next, the signal processor 630 calculates the correlation of the digital signal of black with the digital signal of yellow, thereby obtaining a location where the two digital signals have the largest correlation. As such, the signal processor 630 may obtain the relative location of each color with respect to black, by using the correlations calculated based on black.

The signal processor 630 according to an embodiment may convert a digital signal to binary data of 0 and 1, and calculate a correlation between two digital signals by using a clock.

In detail, the signal processor 630 may shift a value of binary data of one color by one by using a clock and calculate a correlation between binary data of a reference color and binary data of shifted color according to the clock. The signal processor 630 selects a clock having the largest correlation from among the correlations calculated according to the clock as described above, and the selected clock becomes a relative location of the shifted color with respect to the reference color.

However, the obtaining of a correlation between two signals performed by the signal processor 630 according to an embodiment is not limited to using a clock, but various algorithms may be used.

The signal separator 632 and the correlation calculator 633 of the signal processor 630 according to an embodiment may be realized by a digital signal processor (DSP), but is not limited thereto.

The color registration sensor may detect an accurate location of a registration test pattern regardless of a difference between signal levels of each color as the signal processor 630 according to an embodiment calculates correlations of a digital signal of one reference color with digital signals of other colors.

Also, by using correlations of signals of each color, the color registration sensor 100 may accurately detect a location of a registration test pattern even if a peak location of a third voltage signal is wrongly detected due to a noise signal.

FIG. 6B is a graph showing signals processed by the signal processor 630 of FIG. 6A, according to an embodiment.

A third voltage signal 640 shown in FIG. 6B is a first voltage signal from which a noise signal is removed by the noise remover 240. Here, the third voltage signal 640 includes information about all voltage signals of a plurality of colors.

The signal processor 630 according to an embodiment extracts signals of the colors from the third voltage signal 640. Referring to FIG. 6B, the third voltage signal 640 is separated into signals 650 through 680 according to colors. The signal 650 is a signal of black, the signal 660 is a signal of cyan, the signal 670 is a signal of magenta, and the signal 680 is a signal of yellow.

The signal processor 630 according to an embodiment calculates correlations of a digital signal of one reference color with digital signals of other colors, by using the extracted signals 650 through 680.

Accordingly, the signal processor 630 calculates a correlation between the signal 650 of black and the signal 660 of cyan, thereby obtaining a location where the correlation of the signals 650 and 660 is the largest. Also, the signal processor 630 calculates a correlation between the signal 650 of black and the signal 670 of magenta, thereby obtaining a location where the correlation of the signals 650 and 670 is the largest. Then, the signal processor 630 calculates a correlation between the signal 650 of black and the signal 680 of yellow, thereby obtaining a location where the correlation between the signals 650 and 680 is the largest.

As such, the signal processor 630 calculates the correlations of the signal 650 with the signals 660 through 680, thereby obtaining a location of each color with respect to black.

The signal processor 630 according to an embodiment converts a third voltage signal constituting an analog signal to a digital signal, extracts digital signals of colors from the converted third voltage signal, and calculates correlations of a digital signal of one reference color with digital signals of other colors, thereby obtaining a location of each of registration test patterns according to colors.

As such, the signal processor 630 detects the location of registration test pattern of each color by using the correlations between the signals of colors, thereby detecting an accurate location of a registration test pattern without an effect of a noise signal.

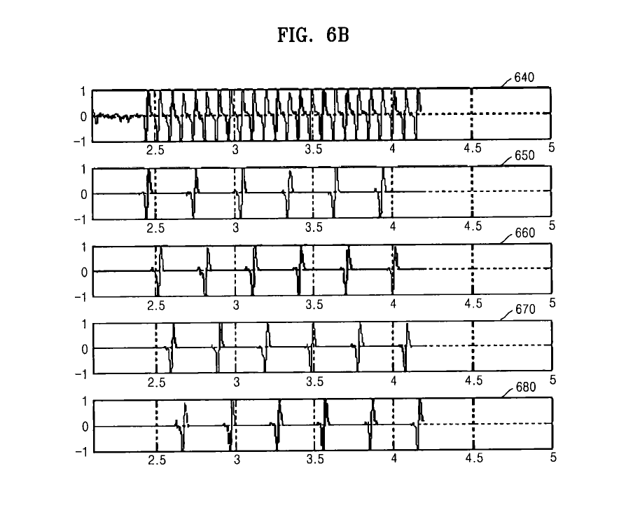

FIG. 7A is a diagram of the electrode unit 230 of FIG. 2, according to an embodiment. An electrode unit 700 shown in FIG. 7A corresponds to the electrode unit 230 of FIG. 2, and overlapping details thereof are not described herein.

Referring to FIG. 7A, the electrode unit 700 includes a first electrode 710, a second electrode 720, an aperture 730, and a ground plate 740.

As described with reference to FIG. 2, the first electrode 710 detects a current generated by an electric force of a charged toner forming registration test patterns, as the registration test patterns of a plurality of colors formed on a transfer medium of an image forming apparatus approach the color registration sensor 100.

The second electrode 720 detects a current for removing a noise signal included in the current detected by the first electrode 710.

The aperture 730 determines a surface exposed to an external space from among an electrode plate forming the first and second electrodes 710 and 720. Accordingly, the first and second electrodes 710 and 720 detect the registration test patterns on the transfer medium through the surface exposed by the aperture 730.

The ground plate 740 grounds remaining portions of the electrode plate forming the first and second electrodes 710 and 720, excluding the surface exposed by the aperture 730. The color registration sensor 100 grounds the first and second electrodes 710 and 720 through the ground plate 740 so as to reduce noise generated in the color registration sensor 100.

The first and second electrodes 710 and 720 included in the electrode unit 700 may have the same shape as a first shape of the registration test patterns. Here, the first shape of the registration test patterns is a bar shape perpendicular to a heading direction of the registration test patterns.

FIG. 7B is a diagram of the electrode unit 230 of FIG. 2, according to an embodiment. Referring to FIG. 7B, an electrode unit 750 includes a first electrode 760, a second electrode 770, an aperture 780, and a ground plate (not shown). The aperture 780 and the ground plate of FIG. 7B are same as the aperture 730 and the ground plate 740, and thus overlapping details thereof are not described herein.

The first and second electrodes 760 and 770 of FIG. 7B respectively correspond to the first and second electrodes 710 and 720 of FIG. 7A. However, the first and second electrodes 760 and 770 of FIG. 7B have different shapes from the first and second electrodes 710 and 720 of FIG. 7A.

Referring to FIG. 7B, the first and second electrodes 760 and 770 included in the electrode unit 750 may have the same shape as the overlapping shape of first and second shapes of the registration test patterns. Here, the second shape of the registration test pattern is a slant shape tilting with respect to both of the heading direction and a direction perpendicular to the heading direction of the registration test patterns.

According to an embodiment, since the first and second electrodes 760 and 770 have the same shape as the overlapping shape of the first and second shapes of the registration test patterns, a degradation of a signal level generated while detecting a registration test pattern having a slant shape by using an electrode plate having the first shape may be prevented.

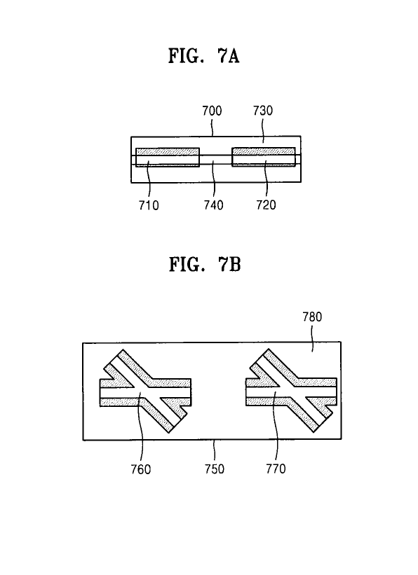

FIG. 8 is a diagram of an image forming apparatus 800 including the color registration sensor 100, according to an embodiment. Referring to FIG. 8, the image forming apparatus 800 includes an exposure unit 810, a photoconductor 820, a developing unit 830, a transfer unit 840, a fixing unit 850, and the color registration sensor 100.

FIG. 8 shows only elements of the image forming apparatus 800 related to an embodiment. Accordingly, it would be obvious to one of ordinary skill in the art that the image forming apparatus 800 may include other general-purpose elements.

Also, since the color registration sensor 100 of FIG. 8 perform the same operations as the color registration sensor 100 described above with reference to FIGS. 1 through 7B, details thereof in FIGS. 1 through 7B are applied to the color registration sensor 100 of FIG. 8.

The exposure unit 810 generates an electrostatic latent image formed by an electrostatic charge by irradiating a light on the photoconductor 820 according to colors. The exposure unit 810 may include a light source, such as a laser beam source.

In detail, the exposure unit 810 forms the electrostatic latent image by irradiating a light corresponding to image information of each color to the photoconductor 820 charged with uniform electric potential. For example, the exposure unit 810 may form an electrostatic latent image of black by irradiating light corresponding to image information of black to the photoconductor 820 charged with uniform electric potential.

As such, the exposure unit 810 may form an electrostatic latent image of each color by irradiating light corresponding to image information of other colors to the photoconductor 820.

The developing unit 830 generates a toner image by developing the electrostatic latent image generated by the exposure unit 810 by using a charged toner. The developing unit 830 may include a developing roller and a toner, i.e., developing rollers 831 through 834 and toners K, Y, M, and C corresponding to a plurality of colors.

In detail, the developing unit 830 may form a toner image of one color by adhering a toner of the corresponding color to an electrostatic latent image of the corresponding color generated by the exposure unit 810. For example, the developing unit 830 may form a toner image of black by adhering a toner of black to an electrostatic latent image of black.

As such, the developing unit 830 forms toner images of other colors by using electrostatic latent images of other colors.

The transfer unit 840 transfers the toner image generated by the developing unit 830 to a transfer medium 845. The transfer unit 840 may include a first support roller 841, a second support roller 842, a first transfer roller 843, a second transfer roller 844, and the transfer medium 845.

In detail, the transfer unit 840 transfers the toner image of each color generated by the developing unit 830 to the transfer medium 845 by using a bias voltage applied to the first transfer roller 843. Here, the transfer medium 845 may be a transfer belt. The transfer medium 845 is supported by the first and second support rollers 841 and 842, is driven to move in a direction indicated by an arrow by the first and second support rollers 841 and 842.

Here, the transfer unit 840 controls a point of time when the exposure unit 810, the developing unit 830, and the first transfer roller 843 starts to operate such that the toner image of each color is accurately overlapped on the transfer medium 845. Accordingly, the transfer unit 840 forms a color toner image on which the toner image of each color is overlapped on the transfer medium 845.

The second transfer roller 844 transfers the color toner image transferred to the transfer medium 845 to a paper P. The color toner image formed on the transfer medium 845 through processes as described above is transferred to the paper P by the second transfer roller 844.

The fixing unit 850 fixes the color toner image on the paper P by using heat and pressure. When the paper P passes through the fixing unit 850, the color toner image transferred to the paper P by the second transfer roller 844 is fixed by heat and pressure, and thus color printing is completed.

Here, in order for the image forming apparatus 800 to print an accurate color image, transfer starting and ending locations of the toner image of each color transferred on the transfer medium 845 may be identical with respect to all colors.

As such, the transfer unit 840 performs color registration, i.e., controls points of time when the exposure unit 810, the developing unit 830, and the first transfer roller 845 start to operate, such that the toner image of each color is accurately overlapped on the transfer medium 845.

The color registration is performed by forming registration test patterns of a plurality of colors on the transfer medium 845, detecting a location of each of the registration test patterns of colors by using the color registration sensor 100, obtaining an error of the registration test pattern of each color, and then compensating for the error.

The color registration sensor 100 detects a current generated by an electric force of a charged toner forming registration test patterns by using a first electrode as the registration test patterns of a plurality of colors corresponding to a toner image transferred on a transfer medium approach the color registration sensor 100, generates a first voltage signal by converting the detected current, and detects a location of each of the registration test patterns of colors by using the first voltage signal.

An error calculator (not shown) calculates an error of color registration by using a location of a registration test pattern detected by the color registration sensor 100.

A controller (not shown) controls units of the image forming apparatus 800 based on the calculated error, thereby compensating for the error.

The image forming apparatus 800 may print an accurate color image by accurately detecting locations of registration test patterns of a plurality of colors by using the color registration sensor 100 according to an embodiment of the present invention.

Besides the units shown in FIG. 8, the image forming apparatus 800 may further include a transmit function performer (not shown) for transmitting a document to be operated to an external apparatus, such as a server, a portable storage medium, or a computer system, a communication interface unit (not shown) for connecting to and communicating with a network, a user interface unit (not shown) for obtaining an input signal from a user and displaying information to the user, and a storage unit (not shown) for storing data, print data, scan data, etc. generated while operating the image forming apparatus 800.

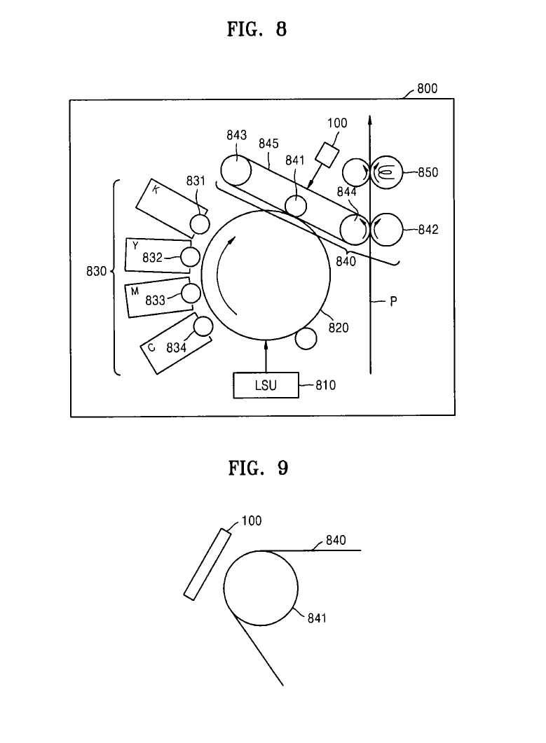

FIG. 9 is a diagram for describing a location of the color registration sensor 100 in the image forming apparatus 800, according to an embodiment.

The color registration sensor 100 according to an embodiment may be disposed above the first support roller 841 of the image forming apparatus 800 while facing the first support roller 841, as shown in FIG. 9.

Referring to FIG. 9, the transfer medium 845 is moved by the first and second support rollers 841 and 842. As the transfer medium 845 moves, the transfer medium 845 may vibrate up and down, and a degree of vibration is highest near the first and second support rollers 841 and 842.

Since the color registration sensor 100 according to an embodiment detects a location of a registration test pattern by using a peak location of a signal, the color registration sensor 100 is not affected by vibration of the transfer medium 845. Accordingly, the color registration sensor 100 according to the current embodiment may be disposed above the first support roller 841, and is not affected by its installation location.

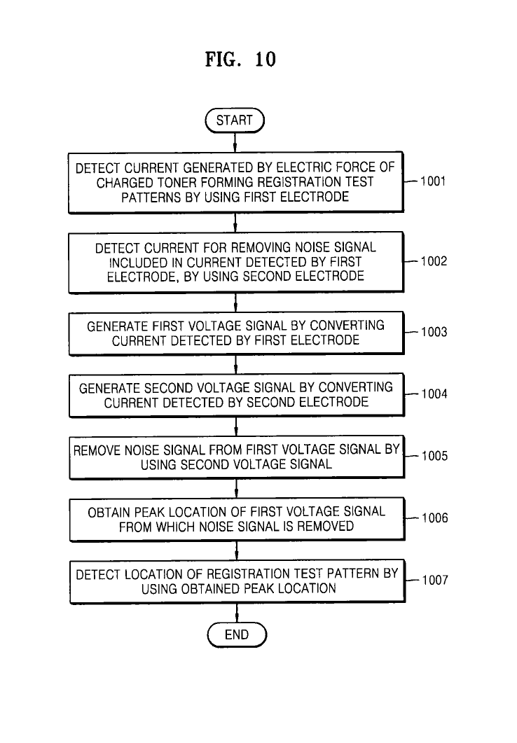

FIG. 10 is a flowchart illustrating a method of detecting registration test patterns by using a color registration sensor, according to an embodiment.

Referring to FIG. 10, the method includes operations performed in time-series by the color registration sensor 100 and the image forming apparatus 800 of FIGS. 1 through 9. Accordingly, even if omitted herein, details about the color registration sensor 100 and the image forming apparatus 800 described with reference to FIGS. 1 through 9 are applied to the method of FIG. 10.

In operation 1001, the electrode unit 230 detects a current generated by an electric force of a charged toner forming registration test patterns, by using the first electrode 110.

In operation 1002, the electrode unit 230 detects a current for removing a noise signal included in the current detected by the first electrode 110, by using the second electrode 210.

In operation 1003, the first voltage generator 120 generates a first voltage signal by converting the current detected by the first electrode 110.

In operation 1004, the second voltage generator 220 generates a second voltage signal by converting the current detected by the second electrode 210.

In operation 1005, the noise remover 240 removes a noise signal from the first voltage signal generated in operation 1003 by using the second voltage signal generated in operation 1004.

In operation 1006, the signal processor 130 obtains a peak location of the first voltage signal from which the noise signal is removed in operation 1005.

In operation 1007, the signal processor 130 detects a location of a registration test pattern by using the peak location obtained in operation 1006.

Since the color registration sensor 100 according to the current embodiment uses a peak location of a voltage signal to which current signal generated by a charged toner is converted, the color registration sensor 100 may detect an accurate location of a registration test pattern even if amplitude of a detected current signal is changed due to a quantity of charge of the charged toner or an installation state of an electrode.

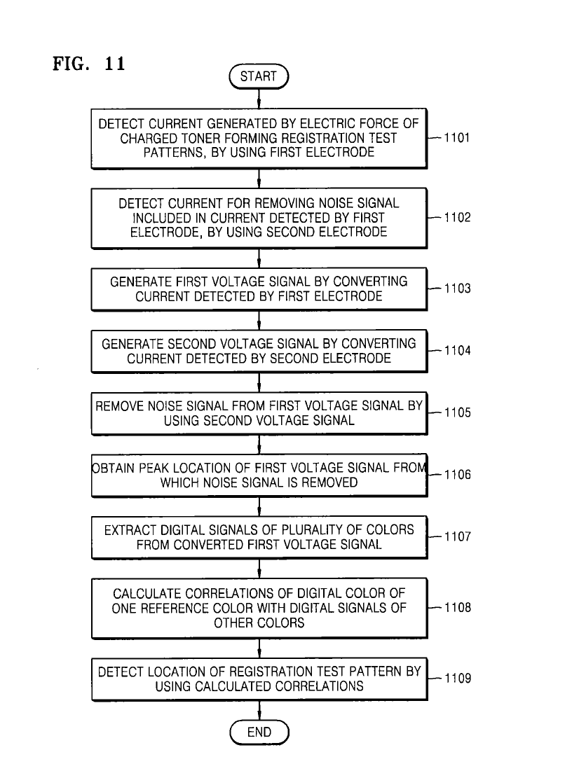

FIG. 11 is a flowchart illustrating a method of detecting registration test patterns by using a color registration sensor, according to an embodiment.

Referring to FIG. 11, the method includes operations performed in time-series by the color registration sensor 100 and the image forming apparatus 800 of FIGS. 1 through 9. Accordingly, even if omitted herein, details about the color registration sensor 100 and the image forming apparatus 800 described with reference to FIGS. 1 through 9 are applied to the method of FIG. 11.

In operation 1101, the electrode unit 230 detects a current generated by an electric force of a charged toner forming registration test patterns, by using the first electrode 110.

In operation 1102, the electrode unit 230 detects a current for removing a noise signal included in the current detected by the first electrode 110, by using the second electrode 210.

In operation 1103, the first voltage generator 120 generates a first voltage signal by converting the current detected by the first electrode 110.

In operation 1104, the second voltage generator 220 generates a second voltage signal by converting the current detected by the second electrode 210.

In operation 1105, the noise remover 240 removes a noise signal from the first voltage signal generated in operation 1103 by using the second voltage signal generated in operation 1104.

In operation 1106, the signal processor 130 converts the first voltage signal from which the noise signal is removed in operation 1105 to a digital signal.

In operation 1107, the signal processor 130 extracts digital signals of a plurality of colors from the first voltage signal converted in operation 1106.

In operation 1108, the signal processor 130 calculates correlations of a digital signal of one reference color with digital signals of other colors.

In operation 1108, the signal processor 130 detects a location of a registration test pattern by using the correlations calculated in operation 1108.

Since the color registration sensor 100 according to the current embodiment extracts digital signals of colors and uses correlations of a digital signal of one reference color with digital signals of other colors, the color registration sensor 100 may detect an accurate location of a registration test pattern by reducing an effect of noise.

According to the embodiments of the present disclosure, a registration test pattern can be effectively detected at a low cost by using a color registrations sensor including an electrode. Also, since a color registration sensor according to an embodiment does not use a light, a registration test pattern may be detected without being affected by an installation location of the color registration sensor and an angle of a lens required to emit and detect a light.

The embodiments of the present disclosure can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), etc.

While this invention has been particularly shown and described with reference to embodiments thereof, it will be understood by those skilled in the art that various changes in form and details may be made therein without departing from the spirit and scope of the invention as defined by the appended claims. The embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A color registration sensor of an image forming apparatus, the color registration sensor comprising:
a first electrode for detecting a current generated by an electric force of a charged toner forming registration test patterns, as the registration test patterns of a plurality of colors formed on a transfer medium of the image forming apparatus approach the color registration sensor;
a first voltage generator for generating a first voltage signal corresponding to the current, by converting the current; and
a signal processor for detecting a location of each of the registration test patterns of the plurality of colors by using the first voltage signal.

2. The color registration sensor of claim 1, wherein the signal processor detects the location of each of the registration test patterns by obtaining a peak location of the first voltage signal.

3. The color registration sensor of claim 1, wherein the signal processor detects the location of each of the registration test patterns by converting the first voltage signal to a digital signal, extracting a digital signal of each of the plurality of colors from the converted first voltage signal, and calculating a correlation of a digital signal of one reference color with digital signals of other colors.

4. The color registration sensor of claim 1, further comprising:
a second electrode for detecting a current for removing a noise signal included in the current detected by the first electrode;
a second voltage generator for generating a second voltage signal corresponding to the current detected by the second electrode, by converting the current detected by the second electrode; and
a noise remover for removing a noise signal from the first voltage signal by using the second voltage signal,
wherein the signal processor detects the location of each of the registration test patterns of the plurality of colors by using the first voltage signal from which the noise signal is removed.

5. The color registration sensor of claim 2, wherein the signal processor obtains the peak location of the first voltage signal by using a differential signal obtained by differentiating the first voltage signal.

6. The color registration sensor of claim 2, wherein the signal processor comprises a slicer circuit for adjusting a value equal to or above a predetermined maximum level to a value of the predetermined maximum level and a value below or equal to a predetermined minimum level to a value of the predetermined minimum level, with respect to each waveform of the first voltage signal and a differential signal obtained by differentiating the first voltage signal, and detects the peak location of the first voltage signal by using the each waveform of the first voltage signal and the differential signal, which passed through the slicer circuit.

7. The color registration sensor of claim 1, further comprising a noise remover for amplifying the first voltage signal, and filtering the amplified first voltage signal by using a low pass filter.

8. The color registration sensor of claim 1, wherein the registration test patterns have a first shape and a second shape, and the first electrode and a second electrode respectively have the same shapes as overlapped shapes of the first and second shapes of the registration test patterns.

9. The color registration sensor of claim 8, wherein the first shape of the registration test patterns has a bar shape perpendicular to a heading direction of the registration test patterns, and the second shape of the registration test patterns has a slant shape tilting in both the heading direction of the registration test patterns and a direction perpendicular to the heading direction.

10. An image forming apparatus comprising a color registration sensor, the image forming apparatus comprising:
an exposure unit for generating an electrostatic latent image consisting of electrostatic charge formed by irradiating a light on a photoconductor according to colors;
a developing unit for generating a toner image by developing the electrostatic latent image by using a charged toner;
a transfer unit for transferring the toner image to a transfer medium;
a color registration sensor for detecting a current generated by an electric force of a charged toner forming registration test patterns by using a first electrode, as the registration test patterns of a plurality of colors formed on the transfer medium approach the color registration sensor, generating a first voltage signal corresponding to the current, by converting the current, and detecting a location of each of the registration test patterns of the plurality of colors by using the first voltage signal;
a color registration error calculator for calculating an error of color registration by using the location of each of the registration test patterns detected by the color registration sensor; and
a controller for controlling units of the image forming apparatus based on the calculated error, so as to compensate for the error.

11. The image forming apparatus of claim 10, wherein the color registration sensor detects the location of each of the registration test patterns by obtaining a peak location of the first voltage signal.

12. The image forming apparatus of claim 10, wherein the color registration sensor detects the location of each of the registration test patterns by converting the first voltage signal to a digital signal, extracting a digital signal of each of the plurality of colors from the converted first voltage signal, and calculating a correlation of a digital signal of one reference color with digital signals of other colors.

13. The image forming apparatus of claim 10, wherein the color registration sensor detects a current for removing a noise signal included in the current detected by the first electrode, by using a second electrode, generates a second voltage signal corresponding to the current detected by the second electrode by converting the current detected by the second electrode, removes a noise signal from the first voltage signal by using the second voltage signal, and detects a location of each of the registration test patterns of the plurality of colors by using the first voltage signal from which the noise signal is removed.

14. A method of detecting registration test patterns of a plurality of colors formed on a transfer medium by using a color registration sensor of an image forming apparatus, the method comprising:
detecting a current generated by an electric force of a toner forming registration test patterns by using a first electrode, as the registration test patterns of a plurality of colors formed on the transfer medium of the image forming apparatus approach the color registration sensor;
generating a first voltage signal corresponding to the current by converting the current; and
detecting a location of each of the registration test patterns of the plurality of colors by using the first voltage signal.

15. The method of claim 14, wherein the detecting of the location comprises:
obtaining a peak location of the first voltage signal; and
detecting a location of each of the registration test patterns by using the peak location.

16. The method of claim 14, wherein the detecting of the location comprises:
converting the first voltage signal to a digital signal;
extracting a digital signal of each of the plurality of colors from the converted first voltage signal;
calculating a correlation of a digital signal of one reference color with digital signals of other colors; and
detecting a location of each of the registration test patterns by using the calculated correlation.

17. The method of claim 15, wherein the detecting of the location comprises:
obtaining a differential signal obtained by differentiating the first voltage signal; and
adjusting a value equal to or above a predetermined maximum level to a value of the predetermined maximum level and a value below or equal to a predetermined minimum level to a value of the predetermined minimum level with respect to each waveform of the first voltage signal and the differential signal, by using the slicer circuit,
wherein the obtaining of the peak location comprises obtaining the peak location of the first voltage signal by using the each waveform of the adjusted first voltage signal and the adjusted differential signal.

18. The method of claim 14, further comprising:
amplifying the first voltage signal; and
filtering the amplified first voltage signal by using a low pass filter,
wherein the detecting of the location comprises detecting the location of each of the registration test patterns of the plurality of colors by using the filtered first voltage signal.

19. The method of claim 14, further comprising:
detecting a current for removing a noise signal included in the current detected by the first electrode, by using a second electrode;
generating a second voltage signal corresponding to the current detected by the second electrode by converting the current detected by the second electrode; and
removing the noise signal from the first voltage signal by using the second voltage signal,
wherein the detecting of the location comprises detecting the location of each of the registration test patterns of the plurality of colors by using the first voltage signal from which the noise signal is removed.

20. A non-transitory computer readable recording medium having recorded thereon a program for executing the method of claim 14.
